(19) United States
(12) Patent Application Publication
(10) Pub. No.: US 2026/0149230 A1
(43) Pub. Date: May 28, 2026

(54) SHIELD CONNECTOR

(71) Applicant: SUMITOMO WIRING SYSTEMS, LTD., Mie (JP)

(72) Inventors: Keisuke KANEMURA, Mie (JP); Norihito HASHIMOTO, Mie (JP)

(21) Appl. No.: 19/395,809

(22) Filed: Nov. 20, 2025

(30) Foreign Application Priority Data
Nov. 25, 2024 (JP) 2024-204803

(51) Int. Cl. H01R 24/50

(52) U.S. Cl. CPC H01R 24/50

(57) ABSTRACT

A shield connector includes a housing to be assembled with an outer conductor. The housing includes a receiving portion having a rear wall surface and a front wall surface facing each other in a front-rear direction. A connecting member includes an inserting portion having plate surfaces facing the rear wall surface and the front wall surface by being arranged in the receiving portion. The inserting portion includes a base end portion and a pair of sandwiching portions extending from the base end portion. A first hollow cylindrical portion is sandwiched by the pair of sandwiching portions. A projecting portion is provided on the rear wall surface of the receiving portion. The inserting portion is pressed against the front wall surface of the receiving portion by contacting the projecting portion.

### CROSS-REFERENCE TO RELATED APPLICATIONS

This application is based on and claims priority from Japanese Patent Application No. 2024-204803, filed on Nov. 25, 2024, with the Japan Patent Office, the disclosure of which is incorporated herein in its entirety by reference.

### TECHNICAL FIELD

The present invention relates to a shield connector.

### BACKGROUND

A connector disclosed in Japanese Patent Laid-open Publication No. 2020-109738 is configured such that an inner conductor is accommodated in a dielectric and the dielectric is surrounded by an outer conductor. The outer conductor is in contact with an electrically conductive enclosure while being accommodated in the enclosure. By the contact of the outer conductor with the enclosure, an improvement in shielding performance can be expected.

### SUMMARY

To ensure the contact of the outer conductor and the enclosure, it is, for example, possible to use a connecting member made of a metal plate material and including a spring piece as in Japanese Patent Laid-open Publication No. 2023-013438. Contact stability can be improved by mounting the connecting member on the outer conductor and resiliently bringing the spring piece into contact with the enclosure.

In such a configuration, it is necessary to stably ensure electrical connection by bringing the connecting member into contact with the outer conductor to improve the shielding performance of the connector. Thus, the connection stability of the connecting member and the outer conductor needs to be ensured.

Accordingly, the present disclosure aims to provide a shield connector capable of improving the reliability of shielding performance.

The present disclosure is directed to a shield connector with a dielectric for accommodating an inner conductor, an outer conductor for accommodating the dielectric, a housing to be attached to the outer conductor, and a connecting member made of a metal plate material, the connecting member being connected to an external ground member and the outer conductor, the housing including a tubular receptacle, the outer conductor including a hollow cylindrical portion extending in a front-rear direction, the housing including a receiving portion having a pair of wall surfaces facing each other across a gap in the front-rear direction, the connecting member including an inserting portion having plate surfaces facing the pair of wall surfaces by being arranged in the receiving portion, the inserting portion including a base end portion and a pair of sandwiching portions extending from the base end portion, the hollow cylindrical portion being sandwiched by the pair of sandwiching portions, a projecting portion being provided on one of the wall surfaces of the receiving portion, and the inserting portion being pressed against the other wall surface of the receiving portion by contacting the projecting portion.

According to the present disclosure, it is possible to provide a shield connector capable of improving the reliability of shielding performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of one embodiment when viewed obliquely from front.

FIG. 2 is a perspective view of the connector shown in FIG. 1 when viewed obliquely from behind.

FIG. 3 is an exploded perspective view of the connector shown in FIG. 1.

FIG. 4 is a plan view of the connector shown in FIG. 1.

FIG. 5 is a partial enlarged view in FIG. 4.

FIG. 6 is a section along A-A of FIG. 5.

FIG. 7 is a section along B-B of FIG. 5.

FIG. 8 is a section along C-C of FIG. 7.

FIG. 9 is a section along D-D of FIG. 7.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
(1) The shield connector of the present disclosure is provided with a dielectric for accommodating an inner conductor, an outer conductor for accommodating the dielectric, a housing to be attached to the outer conductor, and a connecting member made of a metal plate material, the connecting member being connected to an external ground member and the outer conductor, the housing including a tubular receptacle, the outer conductor including a hollow cylindrical portion extending in a front-rear direction, the housing including a receiving portion having a pair of wall surfaces facing each other across a gap in the front-rear direction, the connecting member including an inserting portion having plate surfaces facing the pair of wall surfaces by being arranged in the receiving portion, the inserting portion including a base end portion and a pair of sandwiching portions extending from the base end portion, the hollow cylindrical portion being sandwiched by the pair of sandwiching portions, a projecting portion being provided on one of the wall surfaces of the receiving portion, and the inserting portion being pressed against the other wall surface of the receiving portion by contacting the projecting portion.
According to the configuration of (1), the hollow cylindrical portion of the outer conductor is sandwiched by the pair of sandwiching portions of the inserting portion, whereby the inserting portion contacts the hollow cylindrical portion of the outer conductor and can ensure the connection stability of the connecting member and the outer conductor while ensuring electrical connection. Moreover, since the inserting portion is pressed against the other wall surface of the receiving portion by contacting the projecting portion on the one wall surface of the receiving portion, a state where the inserting portion is planarly disposed along the other wall surface of the receiving portion is maintained. In this way, the connection stability of the connecting member and the outer conductor can be further increased, the electrical connection of the connecting member and the outer conductor can be stably ensured and the reliability of shielding performance can be improved.
(2) Preferably, in the shield connector of (1) described above, the projecting portion is in the form of a thread rib extending along an extension direction of the sandwiching portions.
According to the configuration of (2), since the projecting portion continues to contact the inserting portion in an insertion process of the inserting portion into the receiving portion, the posture of the connecting member in the receiving portion is stabilized.
(3) Preferably, in the shield connector of (2) described above, a pair of the projecting portions are provided in the receiving portion, and the pair of projecting portions respectively extend along both edge parts of the inserting portion with the inserting portion arranged in the receiving portion.
According to the configuration of (3), the both edge parts in a width direction of the inserting portion are supported by the projecting portions, whereby the posture of the connecting member in the receiving portion is further stabilized.
(4) Preferably, in the shield connector of (2) or (3) described above, the projecting portion is in contact with a region from the base end portion to the sandwiching portion with the inserting portion arranged in the receiving portion.
According to the configuration of (4), a contact range of the connecting member and the projecting portion is larger and the posture of the connecting member is further stabilized as compared to a configuration in which the projecting portion is in contact with only the base end portion of the connecting member.
(5) Preferably, in the shield connector of any one of (1) to (4) described above, the hollow cylindrical portion is provided with a projection-like contact point portion for contacting the inserting portion.
According to the configuration of (5), the connecting member and the outer conductor can be reliably brought into contact by the projection-like projecting portion.
(6) Preferably, in the shield connector of (5) described above, a plurality of the contact point portions are provided on the hollow cylindrical portion, and the plurality of contact point portions are disposed at intervals in a circumferential direction on an outer peripheral surface of the hollow cylindrical portion.
According to the configuration of (6), the connection of the connecting member and the outer conductor can be reliably ensured at a plurality of positions and connection reliability between the outer conductor and the connecting member can be enhanced.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

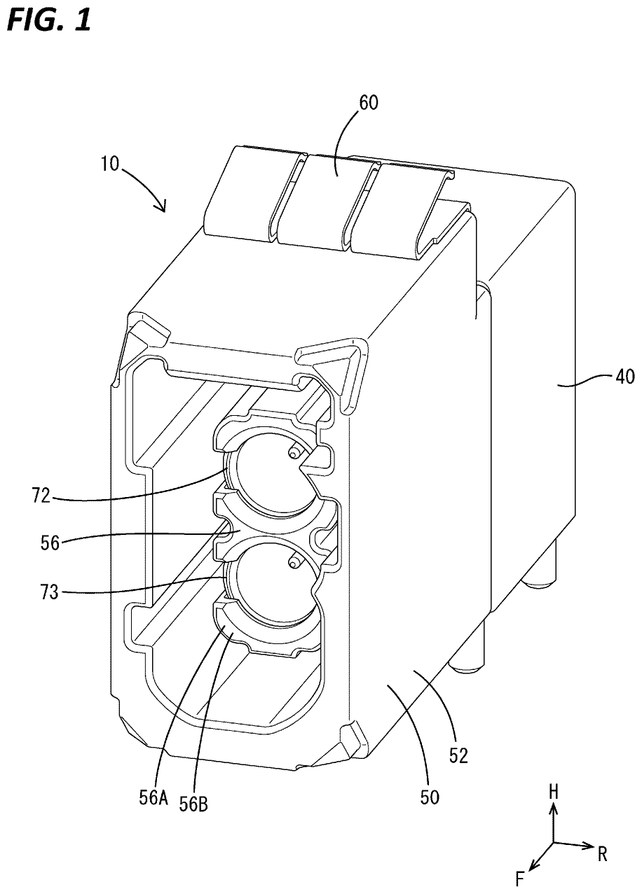

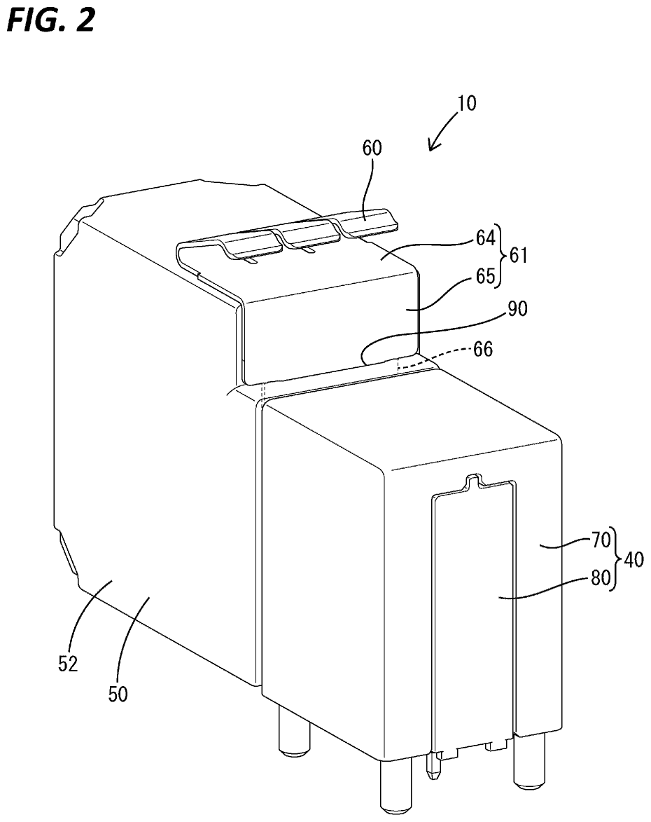

A shield connector 10 of the present disclosure is shown in FIGS. 1 and 2. The shield connector 10 is also merely referred to as a connector 10 below. The connector 10 is a male connector.

In this embodiment, a direction F in FIG. 1 is defined as a forward direction concerning a front-rear direction with respect to the connector 10. A direction R in FIG. 1 is defined as a rightward direction concerning a lateral direction with respect to the connector 10. A direction H in FIG. 1 is defined as an upward direction concerning a vertical direction with respect to the connector 10.

### Configuration of Shield Connector

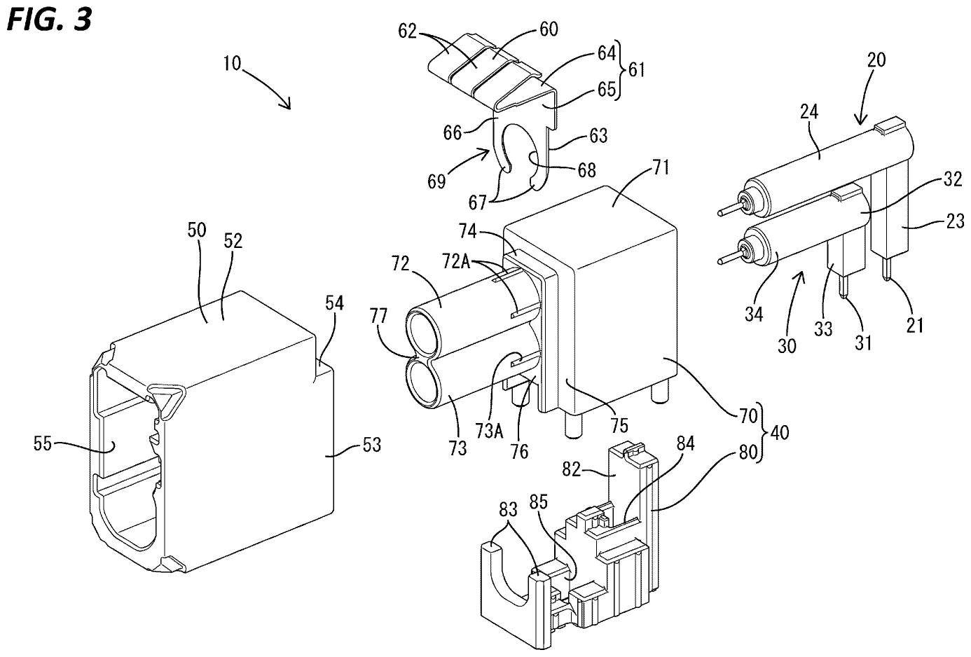

As shown in FIG. 3, the connector 10 is configured by assembling a first terminal module 20, a second terminal module 30, an outer conductor 40, a housing 50 and a connecting member 60.

As shown in FIG. 3, the first terminal module 20 is provided with an L-shaped first inner conductor 21 and an L-shaped first dielectric 22 for accommodating the first inner conductor 21. The first inner conductor 21 corresponds to an “inner conductor” of the present disclosure. The first dielectric 22 corresponds to a “dielectric” of the present disclosure. The first dielectric 22 includes a first mounting side surrounding portion 23 extending in the vertical direction and a first fitting side surrounding portion 24 projecting forward from an upper end part of the first mounting side surrounding portion 23. The second terminal module 30 is provided with an L-shaped second inner conductor 31 and an L-shaped second dielectric 32 for accommodating the second inner conductor 31. The second inner conductor 31 corresponds to the “inner conductor” of the present disclosure. The second dielectric 32 corresponds to the “dielectric” of the present disclosure. The second dielectric 32 includes a second mounting side surrounding portion 33 extending in the vertical direction and a second fitting side surrounding portion 34 projecting forward from an upper end part of the second mounting side surrounding portion 33.

The outer conductor 40 is configured by assembling an upper case 70 and a lower case 80. The upper case 70 is a single component made of metal and formed by forging or casting. The upper case 70 includes a box-shaped accommodating portion 71, a first hollow cylindrical portion 72 and a second hollow cylindrical portion 73. The box-shaped accommodating portion 71 has a rectangular parallelepiped shape with open rear and lower surfaces. A projecting portion 74 is formed in a rectangular region except an upper edge part and both left and right side edge parts, out of the front surface of the box-shaped accommodating portion 71. Out of the front surface of the box-shaped accommodating portion 71, regions sandwiching the projecting portion 74 from both left and right sides function as receiving surfaces 75.

The front surface of the projecting portion 74 functions as a rear facing surface 76 constituted by a flat surface parallel to the receiving surfaces 75. The first hollow cylindrical portion 72 is a part projecting forward from the rear facing surface 76 with an axis oriented in the front-rear direction. The second hollow cylindrical portion 73 is a part projecting forward from the rear facing surface 76 below the first hollow cylindrical portion 72 with an axis oriented in parallel to the first hollow cylindrical portion 72. A lower end part of the first hollow cylindrical portion 72 and an upper end part of the second hollow cylindrical portion 73 are connected via a linking portion 77 over an entire length from a front end to a rear end. The first hollow cylindrical portion 72, the second hollow cylindrical portion 73 and the linking portion 77 form an 8 shape in a front view.

As shown in FIG. 3, since the linking portion 77 is narrower than the first and second hollow cylindrical portions 72, 73, a pair of left and right constricted portions 78 are formed between the first and second hollow cylindrical portions 72, 73.

A plurality of (three in this embodiment) contact point portions 72A in the form of projections for contacting an inserting portion 69 of the connecting member 60 are provided on the outer peripheral surface of the first hollow cylindrical portion 72. The plurality of contact point portions 72A are disposed at intervals in a circumferential direction on the outer peripheral surface of the first hollow cylindrical portion 72. The plurality of contact point portions 72A are provided on a top part and both left and right end parts of the outer peripheral surface of the first hollow cylindrical portion 72. The contact point portion 72A is formed to extend forward from the rear end of the outer peripheral surface of the first hollow cylindrical portion 72. The second hollow cylindrical portion 73 is also provided with a plurality of contact point portions 73A, similarly to the first hollow cylindrical portion 72.

The lower case 80 is a single component made of metal and formed by forging or casting. As shown in FIG. 3, the lower case 80 includes a bottom wall portion 81, a closing portion 82 and a pair of left and right pressing portions 83. The bottom wall portion 81 is formed with a first through hole 84 and a second through hole 85 penetrating through the bottom wall portion 81 in the vertical direction. The second through hole 85 is located in front of the first through hole 84. The closing portion 82 is in the form of a wall projecting upward from a rear end part of the bottom wall portion 81. The pair of pressing portions 83 are shaped to project upward from a front end part of the bottom wall portion 81.

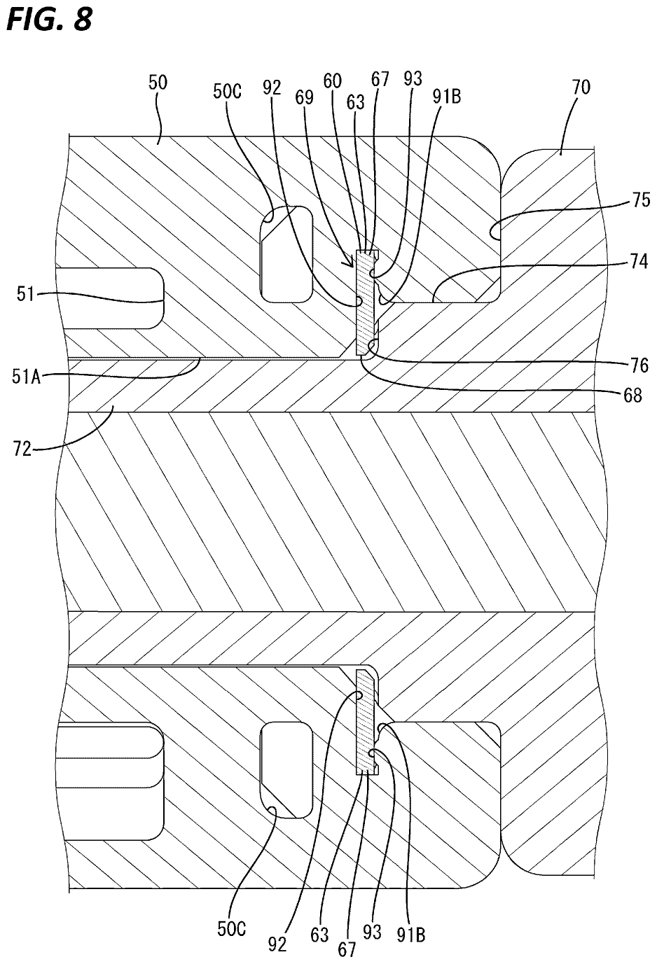

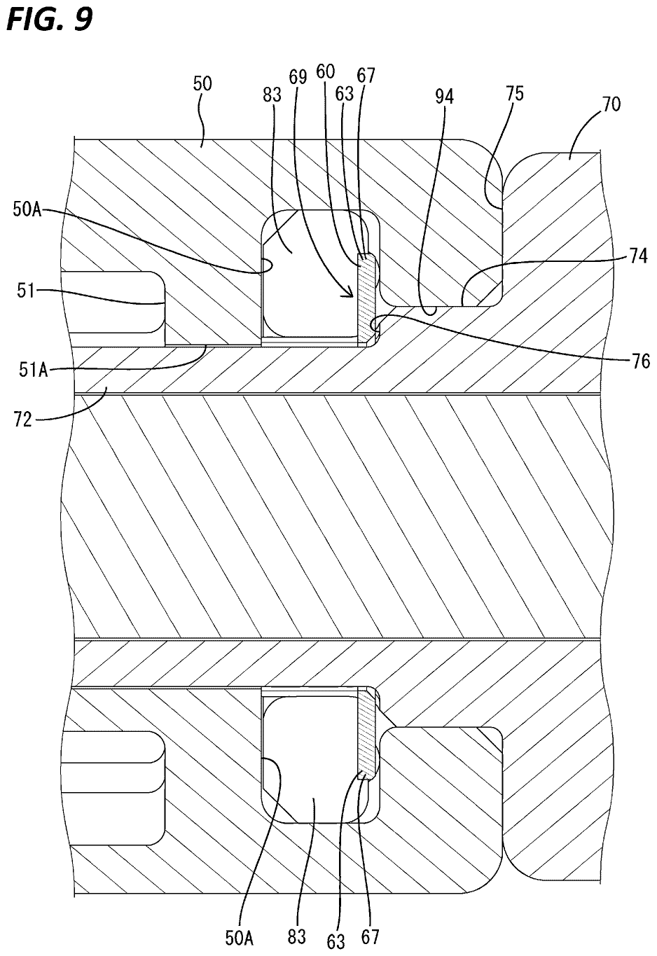

The housing 50 is a box-shaped single component made of synthetic resin and having a rectangular parallelepiped shape as a whole. The housing 50 includes a rear wall portion 51 (see FIGS. 8 and 9) having a thickness direction oriented in the front-rear direction, a receptacle 52 in the form of a rectangular tube projecting forward from the outer peripheral edge of the rear wall portion 51, a pair of bilaterally symmetrical rib-like fitting portions 53 and a holding portion 54. The rear wall portion 51 is formed with a fitting hole 51A (see FIGS. 8 and 9) penetrating through the rear wall portion 51 in the front-rear direction. The pair of rib-like fitting portions 53 are formed to be elongated in the vertical direction along both left and right side edges of the rear wall portion 51.

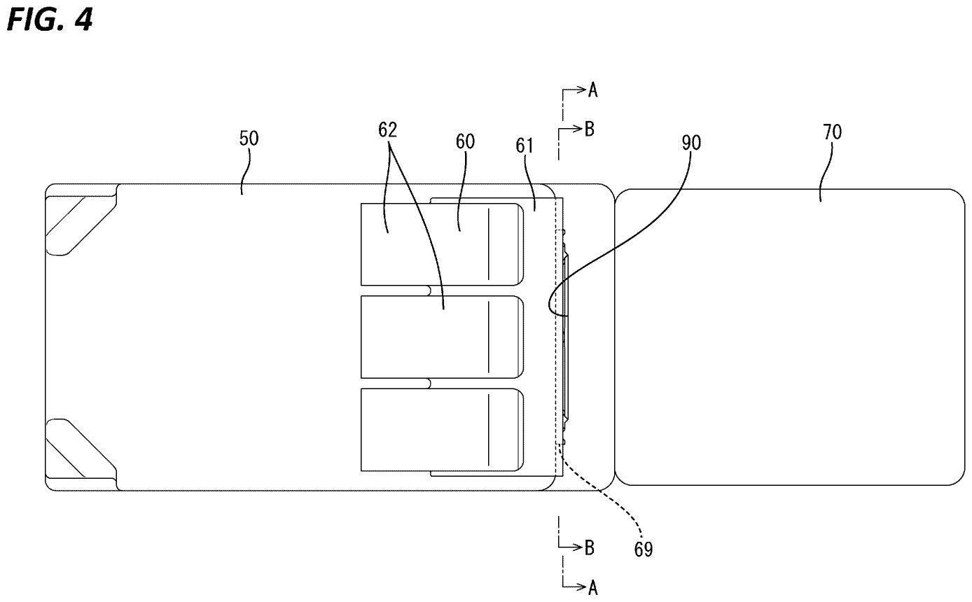

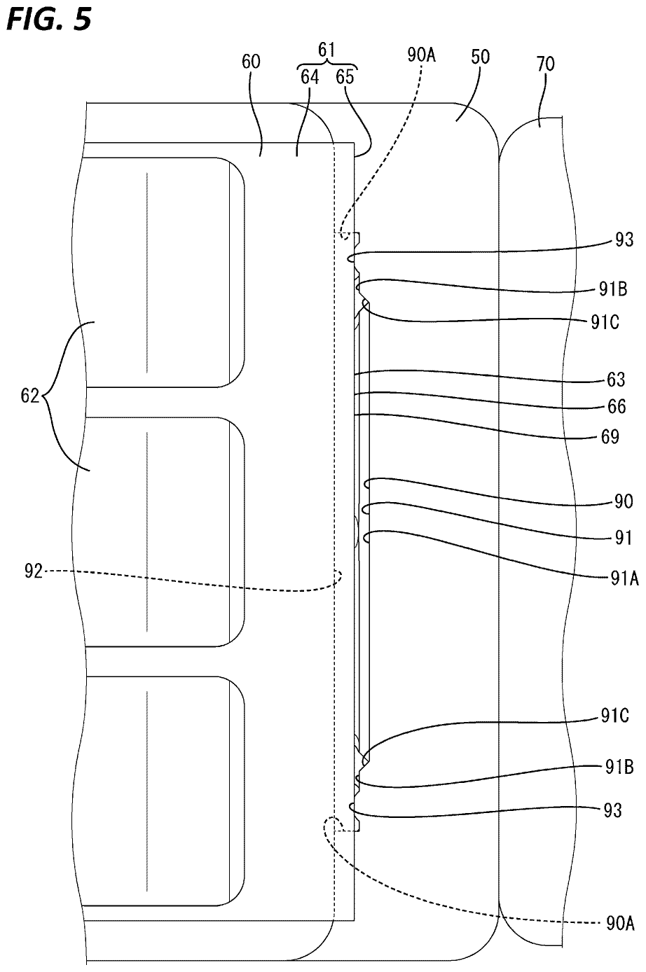

The holding portion 54 is shaped to be elongated in the lateral direction. Both left and right end parts of the holding portion 54 are connected to upper end parts of the both rib-like fitting portions 53. The holding portion 54 is arranged to face the rear surface of the rear wall portion 51 while being spaced apart therefrom. As shown in FIGS. 4 and 5, a receiving portion 90 elongated in the lateral direction and having open upper and lower surfaces is formed between the rear surface of the rear wall portion 51 and the front surface of the holding portion 54. The inside of the receiving portion 90 is configured as a slit. The inserting portion 69 of the connecting member 60 to be described later is inserted into the receiving portion 90.

As shown in FIG. 5, the receiving portion 90 has a rear wall surface 91 and a front wall surface 92 facing each other in the front-rear direction. The front wall surface 92 is a surface orthogonal to the front-rear direction. The lower edge of the front wall surface 92 has an arc shape projecting upward and is facing the outer peripheral surface of an upper end side of the first hollow cylindrical portion 72.

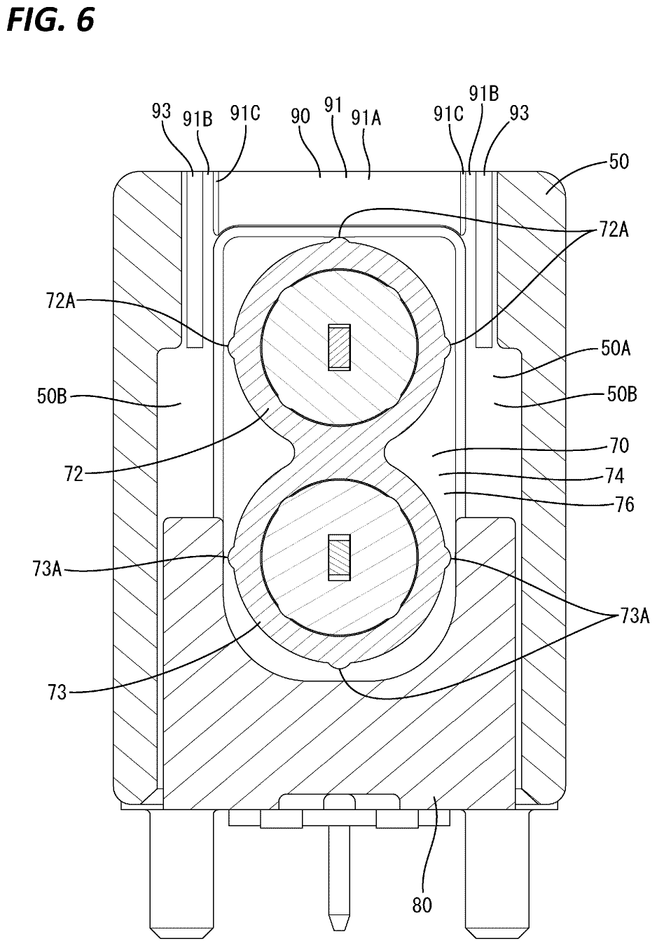

The rear wall surface 91 includes a first wall surface 91A, a pair of second wall surfaces 91B and a pair of inclined surfaces 91C. The first wall surface 91A constitutes a central part in the lateral direction of the rear wall surface 91. The first wall surface 91A is a surface orthogonal to the front-rear direction. As shown in FIG. 6, the first wall surface 91A has a rectangular shape long in the lateral direction.

The pair of second wall surfaces 91B are provided at positions sandwiching the first wall surface 91A in the lateral direction. The second wall surface 91B is connected to the first wall surface 91A via the inclined surface 91C. The pair of inclined surfaces 91C are shaped to be tapered inward in the lateral direction. The second wall surface 91B is a surface orthogonal to the front-rear direction. As shown in FIG. 6, the second wall surface 91B has a rectangular shape extending downward longer than the first wall surface 91A.

A projecting portion 93 projecting forward is provided on the second wall surface 91B. The projecting portion 93 has a semicircular shape convex forward in a plan view. The projecting portion 93 is provided at a position near an outer side in the lateral direction on the second wall surface 91B. The projecting portion 93 is in the form of a thread rib extending in an insertion direction (vertical direction) of the connecting member 60 into the receiving portion 90. The projecting portion 93 is formed over an entire length from the upper end to the lower end of the second wall surface 91B.

For example, an interval between the second wall surface 91B and the rear wall surface 91 is larger than a plate thickness of the connecting member 60 to be described later. For example, an interval between the projecting portion 93 and the rear wall surface 91 is smaller than the plate thickness of the connecting member 60 to be described later.

The receiving portion 90 has a pair of left and right side wall surfaces 90A. The side wall surface 90A is connected to the rear wall surface 91 and the front wall surface 92. The pair of side wall surfaces 90A are facing each other in the lateral direction.

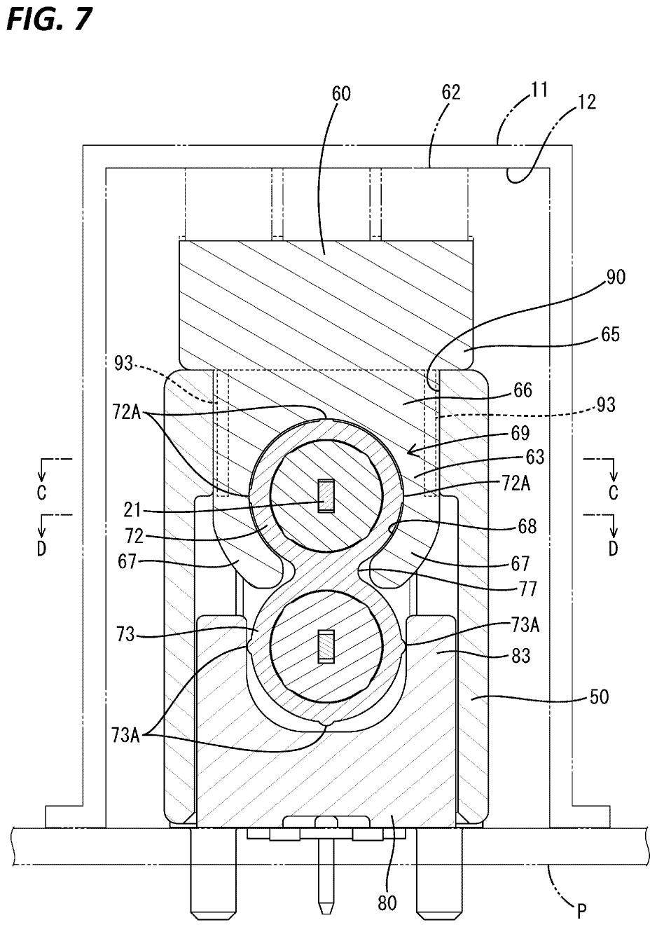

As shown in FIGS. 6 and 7, the receiving portion 90 is connected to a space constituting portion 50A, inside which the rear end of the first hollow cylindrical portion 72, the rear end of the second hollow cylindrical portion 73 and the pair of pressing portions 83 of the lower case 80 are exposed. The second wall surface 91B is connected to a wall surface 50B on a rear side of the space constituting portion 50A. A pair of the wall surfaces 50B are provided at positions sandwiching the projecting portion 74 of the upper case 70 from both left and right sides.

The housing 50 includes a tubular restricting tube portion 56 projecting forward from the rear wall portion 51 in the receptacle 52. The restricting tube portion 56 is a tubular part for restricting the postures of the first and second hollow cylindrical portions 72, 73. The rear end of the restricting tube portion 56 is connected to the fitting hole 51A. The restricting tube portion 56 includes a pair of tube portions 56A vertically arranged and connected. A slit is formed in a part of the outer periphery of the tube portion 56A, but this is not essential. The inner peripheral surface of the tube portion 56A is formed into a circumferential surface having an inner diameter corresponding to outer diameters of the first and second hollow cylindrical portions 72, 73.

The upper tube portion 56A includes an upper tip edge part 56B located further on a tip side (front side) than the tip of the first hollow cylindrical portion 72. That is, the upper tip edge part 56B is an annular part located on the front side beyond the tip of the first hollow cylindrical portion 72. The lower tube portion 56A includes a lower tip edge part 56B located further on the tip side (front side) than the tip of the second hollow cylindrical portion 73. That is, the lower tip edge part 56B is an annular part located on the front side beyond the tip of the second hollow cylindrical portion 73.

The restricting tube portion 56 and an inner wall 55 of the receptacle 52 are separated so that a receptacle (not shown) of a mating housing (not shown) can enter.

The connecting member 60 is a single component formed by bending a metal plate material stamped into a predetermined shape. Therefore, the outer peripheral surface in a plate thickness range along the outer peripheral edge of the connecting member 60 is entirely a fracture surface.

The connecting member 60 includes a base portion 61, a plurality of spring pieces 62 and an arm portion 63. The base portion 61 includes a horizontal plate portion 64 in the form of a rectangular flat plate having a plate thickness direction oriented in the vertical direction and a vertical plate portion 65 in the form of a rectangular flat plate extending downward from the rear end edge of the horizontal plate portion 64. In a side view of the connecting member 60, the base portion 61 is L-shaped. The plurality of (three in this embodiment) spring pieces 62 have a cantilever shape extending obliquely to an upper rear side from the front end edge of the horizontal plate portion 64 and are arranged side by side in the width direction. The spring piece 62 is resiliently deformable in the vertical direction with the front end edge of the horizontal plate portion 64 as a fulcrum.

The arm portion 63 is in the form of a flat plate having a plate thickness direction oriented in the front-rear direction. The arm portion 63 includes a base end portion 66 and a pair of bilaterally symmetrical sandwiching portions 67. The base end portion 66 is a part narrower than the vertical plate portion 65. The pair of sandwiching portions 67 are cantilevered downward from the lower end edge of the base end portion 66. The lower end edge of the base end portion 66 and the inner side edges of the both left and right sandwiching portions 67 form a restricting edge portion 68 having an arc shape in a front view. The restricting edge portion 68 is interrupted in a lower end part. An inner diameter of the restricting edge portion 68 is equal to the outer diameter of the first hollow cylindrical portion 72. An interval in the width direction between the lowermost ends of the pair of sandwiching portions 67 is equal to a width of the linking portion 77.

Next, an assembly procedure of the connector 10 is described. In the outer conductor 40, the first and second terminal modules 20, 30 are inserted into the box-shaped accommodating portion 71 of the upper case 70 from behind with the upper case 70 and the lower case 80 separated. The first fitting side surrounding portion 24 is fit and accommodated into the first hollow cylindrical portion 72, and the second fitting side surrounding portion 34 is fit and accommodated into the second hollow cylindrical portion 73.

In the housing 50, the connecting member 60 is mounted on the holding portion 54. The base portion 61 is positioned with the horizontal plate portion 64 held in contact with a rear end part of the upper surface of the receptacle 52 and the vertical plate portion 65 held in contact with an upper end part of the rear surface of the rear wall portion 51. The arm portion 63 and the base end portion 66 in the connecting member 60 serve as the inserting portion 69 to be inserted into the receiving portion 90. The inserting portion 69 is inserted into the receiving portion 90 from above the housing 50. For example, the inserting portion 69 moves downward while sliding on the projecting portions 93. The inserting portion 69 is arranged in the receiving portion 90 and the plate surfaces thereof face the rear wall surface 91 and the front wall surface 92. Left and right end parts of the inserting portion 69 are respectively in contact with the pair of left and right side wall surfaces 90A. In the receiving portion 90, the inserting portion 69 is held with movements in the front-rear direction and the lateral direction restricted. Specifically, the rear surface of the inserting portion 69 is pressed against the front wall surface 92 of the receiving portion 90 by contacting the projecting portions 93.

Subsequently, the upper case 70 is assembled with the housing 50 from behind. At this time, the first hollow cylindrical portion 72, the second hollow cylindrical portion 73 and the linking portion 77 are press-fit through the fitting hole 51A of the rear wall portion 51 and arranged to protrude forward from the rear wall portion 51 in the receptacle 52. As shown in FIG. 7, the first hollow cylindrical portion 72 and the linking portion 77 are fit into the restricting edge portion 68, whereby the connecting member 60 is restricted from being relatively displaced in the vertical direction and the lateral direction with respect to the upper case 70 (outer conductor 40 and the housing 50). Specifically, the first hollow cylindrical portion 72 is sandwiched by the pair of sandwiching portions 67. The plurality of contact point portions 72A are in contact with the restricting edge portion 68.

As shown in FIG. 7, by sandwiching the first hollow cylindrical portion 72 of the outer conductor 40 by the pair of sandwiching portions 67, the connection stability of the connecting member 60 and the outer conductor 40 (upper case 70) can be ensured while the connecting member 60 contacts the first hollow cylindrical portion 72 of the outer conductor 40 (upper case 70) to ensure electrical connection. Moreover, as shown in FIGS. 5 and 8, the inserting portion 69 of the connecting member 60 contacts the projecting portions 93 on the rear wall surface 91 of the receiving portion 90, thereby being pressed against the front wall surface 92 of the receiving portion 90. Thus, a state where the inserting portion 69 is planarly disposed along the front wall surface 92 of the receiving portion 90 is maintained.

As shown in FIG. 7, the pair of projecting portions 93 extend along an extension direction (vertical direction) of the sandwiching portions 67. The pair of projecting portions 93 are disposed in parallel at positions sandwiching the first hollow cylindrical portion 72 from both left and right sides. The lower ends of the projecting portions 93 are disposed at positions overlapping the first inner conductor 21 in the lateral direction. Since the projecting portions 93 continue to contact the inserting portion 69 in a wide range when the inserting portion 69 is inserted into the receiving portion 90 as compared to a configuration in which the projecting portions 93 are point-like projections, the posture of the connecting member 60 in the receiving portion 90 is stabilized.

The pair of projecting portions 93 respectively extend along both edge parts in the width direction (lateral direction) in the inserting portion 69. Thus, the both edge parts in the width direction (lateral direction) of the inserting portion 69 can be supported by the pair of projecting portions 93. The projecting portion 93 is in contact with a part of the sandwiching portion 67 on the side of the base end portion 66 (upper end side) as well as the base end portion 66.

As shown in FIG. 9, the tips of the pair of sandwiching portions 67 are exposed inside the space constituting portion 50A below the receiving portion 90. The housing 50 is provided with a pair of lightening portions 50C (see FIG. 8) extending upward from the space constituting portion 50A. The lightening portion 50C is located in front of the sandwiching portion 67.

After the upper case 70 is assembled with the housing 50, the lower case 8 is assembled to be press-fit into the upper case 70 from below. The first mounting side surrounding portion 23 is accommodated into the first through hole 84, and the second mounting side surrounding portion 33 is accommodated into the second through hole 85. The rib-like fitting portion 53 is sandwiched in the front-rear direction between the pair of pressing portions 83 and the receiving surfaces 75, thereby restricting the separation of the upper case 70 and the housing 50 in the front-rear direction. The plurality of contact point portions 73A of the second hollow cylindrical portion 73 of the outer conductor 40 are in contact with the pair of pressing portions 83. In the above way, the assembly of the connector 10 is completed.

The assembled connector 10 is mounted on a mounting surface of a circuit board P while being accommodated in an external ground member 11 (see FIG. 7). With the connector 10 mounted on the circuit board P, the spring pieces 62 of the connecting member 60 are resiliently in contact with an upper plate portion 12 of the ground member 11 and the outer conductor 40 and the ground member 11 are conductively connected.

As described above, the shield connector 10 of this embodiment is provided with the dielectric (first dielectric 22) for accommodating the inner conductor (first inner conductor 21), the dielectric (second dielectric 32) for accommodating the inner conductor (second inner conductor 31), the outer conductor 40 for accommodating the dielectrics (first dielectric 22, second dielectric 32), the housing 50 to be attached to the outer conductor 40, and the connecting member 60 made of the metal plate material and to be connected to the external ground member 11 and the outer conductor 40. The housing 50 includes the tubular receptacle 52. The outer conductor 40 includes the hollow cylindrical portions (first hollow cylindrical portion 72, second hollow cylindrical portion 73) extending in the front-rear direction. The housing 50 includes the receiving portion 90 having the pair of wall surfaces (rear wall surface 91, front wall surface 92) facing each other in the front-rear direction. The connecting member 60 includes the inserting portion 69 having the plate surfaces facing the pair of wall surfaces (rear wall surface 91, front wall surface 92) by being arranged in the receiving portion 90. The inserting portion 69 includes the base end portion 66 and the pair of sandwiching portions 67 cantilevered from the base end portion 66. The hollow cylindrical portion (first hollow cylindrical portion 72) is sandwiched by the pair of sandwiching portions 67. The projecting portions 93 are provided on one wall surface (rear wall surface 91) of the receiving portion 90. The inserting portion 69 is pressed against the other wall surface (front wall surface 92) of the receiving portion 90 by contacting the projecting portions 93.

According to this configuration, the first hollow cylindrical portion 72 of the outer conductor 40 is sandwiched by the pair of sandwiching portions 67 of the inserting portion 69, whereby the connection stability of the connecting member 60 and the outer conductor 40 can be ensured while the inserting portion 69 contacts the first hollow cylindrical portion 72 of the outer conductor 40 to ensure electrical connection. Moreover, the inserting portion 69 contacts the projecting portions 93 on the rear wall surface 91 of the receiving portion 90, thereby being pressed against the front wall surface 92 of the receiving portion 90. Thus, the state where the inserting portion 69 is planarly (undeformed state) disposed along the front wall surface 92 of the receiving portion 90 is maintained. In this way, the connection stability of the connecting member 60 and the outer conductor 40 is further enhanced, the electrical connection of the connecting member 60 and the outer conductor 40 can be stably ensured and the reliability of shielding performance can be improved.

In the shield connector 10 of this embodiment, the projecting portions 93 are in the form of thread ribs extending along the extension direction (vertical direction) of the sandwiching portions 67. According to this configuration, since the projecting portions 93 continue to contact the inserting portion 69 in an insertion process of the inserting portion 69 into the receiving portion 90, the posture of the connecting member 60 in the receiving portion 90 is stabilized.

In the shield connector 10 of this embodiment, the receiving portion 90 is provided with the pair of projecting portions 93 and the pair of projecting portions 93 respectively extend along the both edge parts in the width direction (lateral direction) in the inserting portion 69 with the inserting portion 69 arranged in the receiving portion 90. According to this configuration, the both edge parts in the width direction of the inserting portion 69 are supported by the projecting portions 93, whereby the posture of the connecting member 60 in the receiving portion 90 is further stabilized.

In the shield connector 10 of this embodiment, the projecting portions 93 are in contact with regions from the base end portion 66 to the parts of the sandwiching portions 67 on the side of the base end portion 66 with the inserting portion 69 arranged in the receiving portion 90. According to this configuration, contact ranges of the connecting member 60 and the projecting portions 93 are increased and the posture of the connecting member 60 is further stabilized as compared to a configuration in which the projecting portions 93 are in contact with only the base end portion 66 of the connecting member 60.

In the shield connector 10 of this embodiment, the hollow cylindrical portion (first hollow cylindrical portion 72) is provided with the projection-like contact point portions 72A for contacting the inserting portion 69. According to this configuration, the connecting member 60 and the outer conductor 40 can be reliably brought into contact by the projection-like projecting portions 72A.

In the shield connector 10 of this embodiment, the hollow cylindrical portion (first hollow cylindrical portion 72) is provided with the plurality of projection-like contact point portions 72A. The plurality of contact point portions 72A are disposed at intervals in the circumferential direction on the outer peripheral surface of the hollow cylindrical portion (first hollow cylindrical portion 72). According to this configuration, the connection of the connecting member 60 and the outer conductor 40 can be reliably ensured at a plurality of positions and connection reliability between the outer conductor 40 and the connecting member 60 can be enhanced.

### Other Embodiments

The embodiment disclosed this time should be considered illustrative in all aspects, rather than restrictive.

Although the projecting portion 93 is provided on the rear wall surface (second wall surface 91B) in the above embodiment, a projecting portion configured similarly to the projecting portion 93 may be provided not on the rear wall surface 91 (second wall surface 91B), but on the front wall surface 92.

Although the rear wall surface 91 includes the first wall surface 91A, the pair of second wall surfaces 91B and the pair of inclined surfaces 91C in the above between, the rear wall surface 91 may be one flat surface similarly to the front wall surface 92.

Although the projecting portion 93 is in the form of a thread rib in the above embodiment, a plurality of point-like projecting portions may be arranged in the vertical direction in a front view.

Although the projecting portion 93 is in contact with the part of the sandwiching portion 67 on the side of the base end portion 66 (upper side) as well as the base end portion 66 in the above embodiment, the projecting portion 93 may be in contact with an entire part of the sandwiching portion 67 in the vertical direction.

In the above embodiment, the number of the contact point portions 72A provided on the outer peripheral surface of the first hollow cylindrical portion 72 and the number of the contact point portions 73A provided on the outer peripheral surface of the second hollow cylindrical portion 73 are not limited to three.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield connector, comprising:
a dielectric for accommodating an inner conductor;
an outer conductor for accommodating the dielectric;
a housing to be attached to the outer conductor; and
a connecting member made of a metal plate material, the connecting member being connected to an external ground member and the outer conductor,
the housing including a tubular receptacle,
the outer conductor including a hollow cylindrical portion extending in a front-rear direction,
the housing including a receiving portion having a pair of wall surfaces facing each other across a gap in the front-rear direction,
the connecting member including an inserting portion having plate surfaces facing the pair of wall surfaces by being arranged in the receiving portion,
the inserting portion including a base end portion and a pair of sandwiching portions extending from the base end portion,
the hollow cylindrical portion being sandwiched by the pair of sandwiching portions,
a projecting portion being provided on one of the wall surfaces of the receiving portion, and
the inserting portion being pressed against the other wall surface of the receiving portion by contacting the projecting portion.

2. The shield connector of claim 1, wherein the projecting portion is in the form of a thread rib extending along an extension direction of the sandwiching portions.

3. The shield connector of claim 2, wherein:
a pair of the projecting portions are provided in the receiving portion, and
the pair of projecting portions respectively extend along both edge parts of the inserting portion with the inserting portion arranged in the receiving portion.

4. The shield connector of claim 2, wherein the projecting portion is in contact with a region from the base end portion to the sandwiching portion with the inserting portion arranged in the receiving portion.

5. The shield connector of claim 1, wherein the hollow cylindrical portion is provided with a projection-like contact point portion for contacting the inserting portion.

6. The shield connector of claim 5, wherein:
a plurality of the contact point portions are provided on the hollow cylindrical portion, and
the plurality of contact point portions are disposed at intervals in a circumferential direction on an outer peripheral surface of the hollow cylindrical portion.
